(19) United States
(12) Patent Application Publication
(10) Pub. No.: US 2024/0287356 A1
(43) Pub. Date: Aug. 29, 2024

(54) COMPOSITION AND THE USE THEREOF AS JOINT COMPOUND

(71) Applicant: Evonik Operations GmbH, Essen (DE)

(72) Inventors: Andreas Berlineanu, Marl (DE); Gudula Beuers, Dülmen (DE); Margit Bukohl, Marl (DE); Kirsten Luce, Herne (DE); Siegfried Jittenmeier, Marl (DE); Kai-Steffen Krannig, Dortmund (DE); Jürgen Herwig, Hünxe (DE)

(21) Appl. No.: 18/590,673

(22) Filed: Feb. 28, 2024

(30) Foreign Application Priority Data
Feb. 28, 2023 (EP) 23159181.9

(51) Int. Cl. C09J 11/06; C09J 147/00; C08K 3/24; C08K 3/36; C08K 5/5419

(52) U.S. Cl. CPC C09J 11/06; C09J 147/00; C08K 3/24; C08K 3/36; C08K 5/5419

(57) ABSTRACT

The present invention relates to a composition comprising at least one polydiene, preferably at least one polybutadiene, at least two transition metal compounds, at least one silicon compound having at least one vinyl group and having at least two silicon atoms, and at least one wetting agent, where the composition has an Mn compound and a Zr compound as organic transition metal compounds, and to the use of this composition as or for the production of a joint compound, joint sealant, adhesive, putty, filling compound or vibration-damping compound.

The present invention relates to a composition comprising at least one polydiene, preferably at least one polybutadiene, at least two transition metal compounds, at least one silicon compound having at least one vinyl group and having at least two silicon atoms, and at least one wetting agent, where the composition has an Mn compound and a Zr compound as organic transition metal compounds, and to the use of this composition as or for the production of a joint compound, joint sealant, adhesive, putty, filling compound or vibration-damping compound.

The use of butadiene oils that are preferably liquid at room temperature for the production of air-drying resins has long been known in the prior art for example from Rompps Chemie-Lexikon, 8th ed., page 3280 (Heidel and Dittmann, Chimia, 22 (1968, p. 213-218)). However, in the past butadiene oils have found little acceptance in the building sector owing to the difficulty in processing them. The liquid polybutadiene oils are known to dry out relatively quickly under the action of atmospheric oxygen, and so storage under protective gas is recommended, which is complex. The use of solvents such as white spirits to adjust the viscosity of the polybutadiene oils also involves certain difficulties if the product to be consolidated with the polybutadiene oils is intended to be air-dried at customary ambient temperatures, such as room temperature. Furthermore, the commercially available polybutadiene oils react extremely easily with water, with the result that to date the building materials to be connected have had to be used in a particularly dry, virtually anhydrous form.

Numerous efforts were made in the 1970s and 1980s to improve the consolidation of sand and the greening of areas using liquid polybutadienes.

DE 3300750 A1 describes a process for the production of mouldings having improved wet strength that essentially consist of sand and an organic binder that crosslinks by means of atmospheric oxygen in a manner known per se, where the binder used in the preparation of the moulding compositions is an additive—and auxiliary-containing homopolymer or copolymer of 1,3-dienes which bears reactive silyl groups, has an average molecular weight (Mn) of 500 to 8000, and has a content of cis-1,4 double bonds of at least 35% and a silicon content of 0.1 to 10 percent by weight. The reactive silyl group-bearing polymers of 1,3-dienes used are obtained, as described in DE 3028839 A1, by reacting the polymers based on 1,3-dienes with a vinylsilane.

DE3436556 A1 (CA 1248271 A1) describes heat-crosslinkable compounds which consist of a binder and conventional additives, with additives that catalyse cold crosslinking being excluded, and a process for producing cold-crosslinking compounds, which consists in mixing together a binder, an effective amount of an additive that catalyses the cold crosslinking, and further conventional additives. The binder is a combination of two binders which are capable of crosslinking with one another without addition of a crosslinking agent. Used as binder is on the one hand a primary and/or secondary hydroxyl group-bearing polymer based on 1,3-butadiene and on the other hand a polymer based on 1,3-butadiene with pendant succinic anhydride groups. The compounds are of interest for an extraordinarily diverse number of applications, for example as joint sealants, adhesives, putties, filling compounds and vibration-damping compounds.

DE 4035359 C1 describes air-drying binders based on polybutadiene oils that are liquid at room temperature and solvents, and the use thereof for the consolidation of building materials, residual materials, waste materials and other materials. Used as solvents or diluents for the polybutadiene oils are aromatic-free aliphatic hydrocarbons having an evaporation number in accordance with DIN 53 170 in the range from 100 to 1000 and/or turpentine oil. What is recommended is the addition of organic transition metal salts/compounds to accelerate consolidation, the addition of alkyltrialkoxysilane for hydrophobization and the addition of nonylphenol ethoxylates to improve wetting.

However, monosilanes and nonylphenol ethoxylates are often compounds that are subject to labelling requirements (for example nonylphenyl ethoxylate is labelled as acutely toxic, seriously damaging to the eyes and as hazardous to water), that is to say compounds that can potentially cause damage to health upon contact.

EP 4 186 878 A1 discloses a composition composed of polybutadiene, organic cobalt compounds and organic manganese compounds.

The object of the present invention was therefore to provide compounds particularly for applications as joint compound, joint sealant, adhesive, putty, filling compound and vibration-damping compound which avoid one or more of the abovementioned disadvantages.

It has surprisingly been found that a composition comprising at least one polydiene, at least one Mn compound and one Zr compound as organic transition metal compounds, at least one silicon compound having at least one vinyl group and having at least two silicon atoms, and at least one wetting agent achieves this object.

The present invention therefore provides compositions as claimed in the claims and described hereinafter.

The present invention also provides for the use of the compositions according to the invention as or for the production of a joint compound, joint sealant, adhesive, putty, filling compound or vibration-damping compound as claimed in the claims and described hereinafter.

The compositions according to the invention have the advantage that they are (essentially) free of monosilanes, particularly vinyltrimethoxysilane or vinyltrichlorosilane, and nonylphenol ethoxylates and it is thus possible to rule out any health impairment as a result of these substances upon contact with the composition. Despite the use of different materials, test specimens produced from said compositions exhibit the same or even better properties, particularly for flexural tensile strength.

In addition, the preferred use of wollastonite instead of some of the finely divided silica sand that is otherwise used makes it possible to achieve a significant increase in the flexural tensile strength.

The preferred use of a mixture of organic manganese and zirconium compounds instead of cobalt compounds makes it possible to achieve a higher final strength and a higher flexural tensile strength of the test specimens regardless of the silica sand used.

The compositions according to the invention, a process for the production thereof and the use according to the invention of the compositions are described by way of example hereinafter, without any intention that the invention be restricted to these illustrative embodiments. Where ranges, general formulae or classes of compounds are specified hereinafter, these are intended to encompass not only the corresponding ranges or groups of compounds that are explicitly mentioned but also all subranges and subgroups of compounds that can be obtained by removing individual values (ranges) or compounds. Where documents are cited in the context of the present description, their content shall fully form part of the disclosure content of the present invention, particularly in respect of the matters referred to. Where figures are given in percent hereinafter, these are percentages by weight unless otherwise stated. Where average values, for example molar mass average values, are specified hereinafter, these are the numerical average unless stated otherwise. Where properties of a material are specified hereinafter, for example viscosities or the like, these are the properties of the material at 25° C. unless stated otherwise. Where chemical (empirical) formulas are used in the present invention, the specified indices may be not just absolute numbers but also average values. In the case of polymeric compounds, the indices preferably represent average values.

In the context of the present invention, polydienes are understood to mean those polymers based on alkenes and/or polyenes having at least two olefinic double bonds as monomers. In the context of the present invention, the repeat units of the polydienes consist exclusively of the elements carbon and hydrogen and include no aromatic structures. The polydienes may contain any desired proportion of double bonds.

The composition according to the invention comprising at least one polydiene, preferably at least one polybutadiene, at least two transition metal compounds, at least one silicon compound having at least one vinyl group and having at least two silicon atoms, and at least one wetting agent is characterized in that the composition has an Mn compound and a Zr compound as organic transition metal compounds. Preferably, the silicon compound having at least two silicon atoms conforms to empirical formula (I)

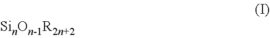

where n is greater than or equal to 2, preferably 2 to 20, preferably 2.5 to 10 and particularly preferably 3 to 6, R is the same or different and is an alkenyl radical, preferably a vinyl radical, an alkyl radical, preferably an alkyl radical having 1 to 4 carbon atoms, an alkoxy radical, preferably an alkoxy radical having 1 to 4 carbon atoms, a halogen radical, preferably a chlorine radical, with the proviso that at least one radical R is a vinyl radical.

Preferred silicon compounds having at least two silicon atoms conform to formula (Ia)

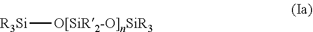

where n is greater than or equal to 2, preferably 2 to 20, preferably 2.5 to 10 and particularly preferably 3 to 6, R is the same or different and is an alkenyl radical, preferably a vinyl radical, an alkyl radical, preferably an alkyl radical having 1 to 4 carbon atoms, an alkoxy radical, preferably an alkoxy radical having 1 to 4 carbon atoms, a halogen radical, preferably a chlorine radical, and R′ is the same as R or includes a radical of the Si—O units, preferably R′ is the same as R, and with the proviso that at least one radical R is a vinyl radical.

Silicon compounds that are usable according to the invention and have at least one vinyl group and at least two silicon atoms are for example organomodified siloxanes, as can be obtained for example from Evonik Operations GmbH. Preference is given to using oligomeric siloxanes containing vinyl groups and methoxy groups, for example Dynasylan® 6490 from Evonik Operations GmbH. The preparation of such organomodified siloxanes is described for example in WO 2013/076036 A1.

The Mn and Zr compounds present in the composition according to the invention as organic transition metal compounds are preferably a salt of an organic acid, preferably a carboxylic acid having 4 to 12, preferably 7 to 10, carbon atoms. Preferred transition metal compounds are the octanoates of the corresponding transition metals. Particularly preferably manganese octoate and zirconium octoate are present in the composition according to the invention.

Preferably, at least one of the polydienes present in the composition according to the invention comprises or consists of the 1,3-butadiene-derived monomer units

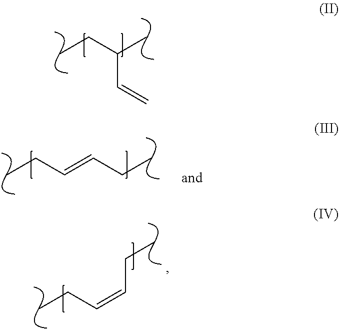

with the proviso that the monomer units (II), (III) and (IV) may be arranged in blocks or in random distribution and based on the polybutadiene the percentage of the monomer unit (II)=1 to 30 mole percent, preferably 1 to 10 mole percent, based on the monomer unit (III)=9 to 40 mole percent, preferably 19 to 30 mole percent, and the proportion of the monomer unit (IV) is 50 to 90 mole percent, preferably 60 to 80 mole percent, where a square bracket in the chosen formula representation of the 1,3-butadiene-derived monomer units (II), (III) and (IV) present in the polybutadiene shows that the bond endowed with the respective square bracket does not end with a methyl group, for instance, but that the corresponding monomer unit is bonded via this bond to a further monomer unit or a hydrogen.

The polydiene may additionally include, in a proportion of up to 5 mole percent based on the polybutadiene, one or more branching structures of formula (V), (VI) or (VII)

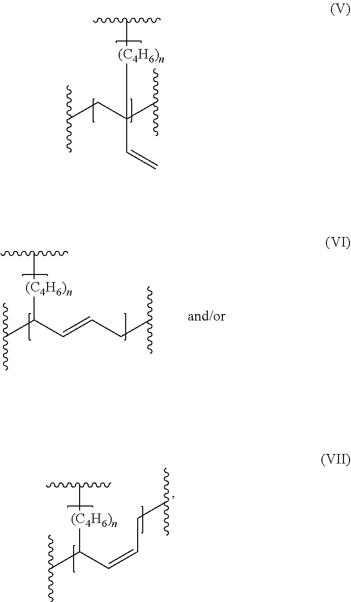

where “(C₄H₆)ₙ” corresponds to a butadiene oligomer comprising or preferably consisting of the repeat units (II), (III) and (IV).

The number-average molecular weight Mn of the polybutadienes, determined by gel permeation chromatography as described in the Example section, is preferably from 500 to 10 000 g/mol, more preferably from 1000 to 5000 g/mol and particularly preferably from 1500 to 4000 g/mol.

In addition, the polybutadiene may be in partly or fully hydrogenated form. The polybutadiene is however preferably in unhydrogenated form.

Suitable polydienes, in particular polybutadienes, may be obtained for example from Evonik Operations GmbH.

Wetting agents used may be all known compounds or mixtures, in particular surfactants, that are suitable as wetting agents. Preferably, wetting agents used are compounds that do not have any aromatic rings, and preferably are polymeric compounds based on ethylene oxide and 3,5,5-trimethylhexyl alcohol and optionally further compounds. Suitable wetting agents are offered for example by Evonik Operations GmbH under the TEGO® WET name. Particularly suitable is TEGO® WET 500, which comprises polymeric compounds based on ethylene oxide and 3,5,5-trimethylhexyl alcohol.

The composition according to the invention preferably comprises from 92 to 97 parts by weight of polybutadiene, from 2.5 to 5 parts by weight of at least one silicon compound having at least one vinyl group and having at least two silicon atoms, from 0.5 to 2.5 parts by weight of wetting agent, from 0.1 to 2 parts by weight of organic Zr compound and from 0.2 to 2.5 parts by weight of organic Mn compound. Calculated as metal, the composition according to the invention preferably comprises from 0.012 to 0.24 parts by weight of Zr and from 0.02 to 0.25 parts by weight of manganese.

Particularly when they are intended to be used as construction materials, the compositions according to the invention may comprise at least one mineral building material, preferably cement, sand, clay, gravel, crushed stone and/or gypsum, particularly preferably sand and/or cement. The proportion of mineral building materials in the overall composition is preferably from 90% to 99% by weight and very particularly preferably from 95% to 98% by weight.

The compositions according to the invention may be produced in a simple manner by mixing the individual components. If the compositions according to the invention comprise mineral building materials, then the components that are not mineral building materials are preferably mixed before the mineral building material or materials are added. The mixing may be effected in commercially available mixers. The mixing may be effected with exclusion of air, under for example nitrogen, or under an air atmosphere. The mixing is preferably effected under protective gas, preferably under nitrogen.

The compositions according to the invention may be used as or for the production of for example a joint compound, joint sealant, adhesive, putty, filling compound or vibration-damping compound.

### EXAMPLES

### Test Methods:

### 1. Gel Permeation Chromatography

The number-average molecular weight Mn and the weight-average molecular weight Mw of the polymers used in the context of the present invention are determined in accordance with DIN 55672-1 by means of gel permeation chromatography in tetrahydrofuran as eluent and polystyrene for calibration. Polydispersity (U)=Mw/Mn.

### 2. Flexural Strength Investigation

Flexural strength was investigated on a Spekt 10-1 table from Hegewald & Peschke in accordance with DIN 51902. For this purpose, the test specimen is placed in the measuring device (span of 50 mm) and the pressure foot is carefully moved towards the test specimen. Then, the pressure foot is pressed against the test specimen with a constant speed (5 mm/min) and the force absorption is recorded in dependence on the path length. The experiment is considered to have ended when the force absorption has fallen to 10% of the maximally applied force.

### 3. Water Absorption Investigation

Water absorption was investigated on a cylindrical test specimen (diameter 4 cm, height 1 cm). For this purpose, a water droplet (0.05 ml) is placed onto the surface of the test specimen using a disposable pipette and the time until the water has been completely absorbed into the test specimen is measured.

### Raw Materials Used:

POLYVEST® 110: polybutadiene from Evonik Operations GmbH
DYNASYLAN® VTMO: vinyltrimethoxysilane from Evonik Operations GmbH
DYNASYLAN® 6490 from Evonik Operations GmbH
TEGO® WET 500 from Evonik Operations GmbH
MARLOPHEN® NP 8.5: nonylphenol polyglycol ether from Sasol Olefin & Surfactants GmbH
Cobalt octoate
OCTA-SOLIGEN® Cobalt 10 (50-60%), cobalt octoate from Borchers GmbH
OCTA-SOLIGEN® Manganese 10 (55-65%), manganese octoate from Borchers GmbH
OCTA-SOLIGEN® Zirconium 12 HS (30-40%), zirconium octoate from Borchers GmbH
Silica sand H31 from Quarzwerke GmbH, Haltern manufacturing plant (hereinafter H31)
Silica sand H35 from Quarzwerke GmbH, Haltern manufacturing plant (hereinafter H35)

### Example 1 (Comparative Example)

94.62 g of POLYVEST® 110, 3.0 g of DYNASYLAN® VTMO, 1.43 g of MARLOPHEN® NP 8.5 and 0.95 g of OCTA-SOLIGEN® Cobalt 10 were combined in a glass vessel and the mixture was homogenized by vigorous stirring. Subsequently, 3.0 g of the mixture are combined with 97 g of H31 and vigorous mixing is performed. The finished compound was filled into the specimen mould, smoothed flat and cured at the desired temperature. The results of the test can be found in Table 1.

### Example 2 (Comparative Example)

94.6 g of POLYVEST® 110, 3.0 g of DYNASYLAN® 6490, 1.4 g of TEGO® WET 500 and 1.0 g of OCTA-SOLIGEN® Cobalt 10 are combined in a glass vessel and the mixture is homogenized by vigorous stirring. Subsequently, 3.0 g of the mixture are combined with 97 g of the corresponding filler (H31 or H35) or 3.0 g of the mixture are combined with 80 g of H35 and 15 g of wollastonite and vigorous mixing is performed. The finished compounds were filled into the specimen mould, smoothed flat and cured at the desired temperature. The results of the test can be found in Table 1.

### Example 3 (Inventive)

93.0 g of POLYVEST® 110, 3.0 g of DYNASYLAN® 6490, 1.4 g of TEGO® WET 500, 1.6 g of OCTA-SOLIGEN® Manganese 10 and 1.0 g of OCTA-SOLIGEN® Zirconium 12 HS are combined in a glass vessel and the mixture is homogenized by vigorous stirring. Subsequently, 3.0 g of the mixture are combined with 97 g of the corresponding filler (H31 or H35, see Table 1) and vigorous mixing is performed. The finished compounds were filled into the specimen mould, smoothed flat and cured at the desired temperature. The results of the test can be found in Table 1.

Flexural strength and water absorption were investigated using a few test specimens at different points in time during the curing. For the curing, the test specimens (10×10×65 mm) were stored first for 2 hours at 55° C. (reference in Table 1: 2 h) and then for 7 days at 25° C., 1013 hPa and 50% humidity (reference in Table 1: 7 days). The results of the test can be found in Table 1.

TABLE 1

| | Flexural strength in | | Water absorption in | |
|---|---|---|---|---|
| | N/mm² after drying for | | seconds after drying for | |
| | 2 h | 7 days | 2 h | 7 days |
| Example 1: H31 | 2.9 | 3.1 | — | — |
| Example 2: H31 | 2.6 | 3.5 | 99 | 0 |
| Example 2: H35 | 5 | 7.5 | 90 | 0 |
| Example 2: H35 + | 10.37 | 16 | — | — |
| wollastonite | | | | |
| Example 3: H31 | 1.68 | 7.25 | 94 | 0 |
| Example 3: H35 | 2.83 | 9.95 | 134 | 0 |

— = not determined
0 = no absorption

As can be inferred from Table 1, use of the formulations according to the invention makes it possible to obtain test specimens that have essentially the same flexural tensile strength as test specimens that have been produced using formulations comprising the components from the prior art. In addition, substituting part of the finely divided silica sand H35 with wollastonite makes it possible to achieve a significant increase in the flexural tensile strength.

As can be inferred from the values for the test of the test specimens according to Example 3, a significantly higher (final) flexural tensile strength can also be achieved after curing for 7 days if a system composed of manganese and zirconium compounds is used instead of a cobalt compound.

As can also be inferred from Table 1, the water absorption is lowest after a brief curing time if the formulation according to Example 3 with H35 is used.

1. Composition comprising at least one polydiene, preferably at least one polybutadiene, at least two transition metal compounds, at least one silicon compound having at least one vinyl group and having at least two silicon atoms, and at least one wetting agent, wherein the composition has an Mn compound and a Zr compound as organic transition metal compounds.

2. The composition according to claim 1, wherein the silicon compound having at least two silicon atoms conforms to empirical formula (I) 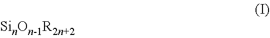
where n is greater than or equal to 2, preferably 2 to 20, preferably 2.5 to 10 and particularly preferably 3 to 6, R is the same or different and is an alkenyl radical, preferably a vinyl radical, an alkyl radical, preferably an alkyl radical having 1 to 4 carbon atoms, an alkoxy radical, preferably an alkoxy radical having 1 to 4 carbon atoms, a halogen radical, preferably a chlorine radical, with the proviso that at least one radical R is a vinyl radical.

3. The composition according to claim 1, wherein the silicon compound having at least two silicon atoms conforms to formula (Ia) 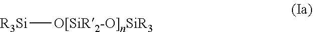
where n is greater than or equal to 2, preferably 2 to 20, preferably 2.5 to 10 and particularly preferably 3 to 6, R is the same or different and is an alkenyl radical, preferably a vinyl radical, an alkyl radical, preferably an alkyl radical having 1 to 4 carbon atoms, an alkoxy radical, preferably an alkoxy radical having 1 to 4 carbon atoms, a halogen radical, preferably a chlorine radical, and R′ is the same as R or includes a radical of the Si—O units, preferably R′ is the same as R, with the proviso that at least one radical R is a vinyl radical.

4. The composition according to claim 1, wherein manganese octoate and zirconium octoate are present as transition metal compounds.

5. The composition according to claim 1, wherein the at least one polydiene comprises or preferably consists of the 1,3-butadiene-derived monomer units 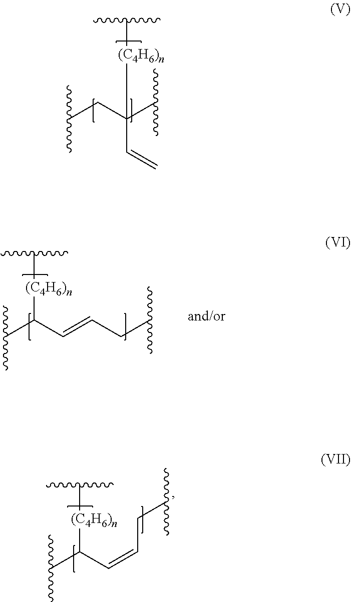
with the proviso that the monomer units (II), (III) and (IV) may be arranged in blocks or in random distribution and based on the polybutadiene the percentage of the monomer unit (II)=1 to 30 mole percent, based on the monomer unit (III)=9 to 40 mole percent and the proportion of the monomer unit (IV) is 50 to 90 mole percent, where a square bracket in the chosen formula representation of the 1,3-butadiene-derived monomer units (II), (III) and (IV) present in the polybutadiene shows that the bond endowed with the respective square bracket does not end with a methyl group, for instance, but that the corresponding monomer unit is bonded via this bond to a further monomer unit or a hydrogen.

6. The composition according to claim 5, wherein the polydiene additionally includes, in a proportion of up to 5 mole percent based on the polybutadiene, one or more branching structures of formula (V), (VI) or (VII) 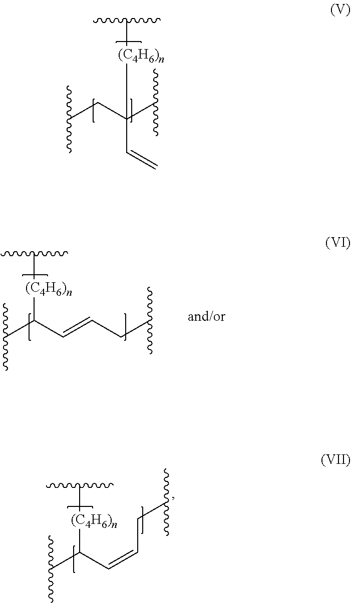
where “(C₄H₆)ₙ” corresponds to a butadiene oligomer comprising or preferably consisting of the repeat units (II), (III) and (IV).

7. The composition according to claim 1, wherein wetting agents used are compounds that do not have any aromatic rings, and preferably are polymeric compounds based on ethylene oxide and 3,5,5-trimethylhexyl alcohol and optionally further compounds.

8. The composition according to claim 1, wherein the composition comprises from 92 to 97 parts by weight of polybutadiene, from 2.5 to 5 parts by weight of at least one silicon compound having at least one vinyl group and having at least two silicon atoms, from 0.5 to 2.5 parts by weight of wetting agent, from 0.1 to 2 parts by weight of organic Zr compound and from 0.2 to 2.5 parts by weight of organic Mn compound.

9. The composition according to claim 1, wherein the composition comprises at least one mineral building material, preferably cement, sand, clay, gravel, crushed stone and/or gypsum, particularly preferably sand and/or cement.

10. The composition according to claim 9, wherein the proportion of mineral building materials in the overall composition is from 90% to 99% by weight and very particularly preferably from 95% to 98% by weight.

11. Use of compositions according to claim 1 as or for the production of a joint compound, joint sealant, adhesive, putty, filling compound or vibration-damping compound.
